(19) United States
(12) Patent Application Publication
(10) Pub. No.: US 2024/0093613 A1
(43) Pub. Date: Mar. 21, 2024

(54) METHOD FOR COATING A TIP OF AN AEROFOIL AND AEROFOIL

(71) Applicant: ROLLS-ROYCE plc, London (GB)

(72) Inventors: Andrew HEWITT, Derby (GB); Matthew HANCOCK, Derby (GB)

(73) Assignee: ROLLS-ROYCE plc, London (GB)

(21) Appl. No.: 18/242,816

(22) Filed: Sep. 6, 2023

(30) Foreign Application Priority Data
Sep. 20, 2022 (GB) 2213705.3

(51) Int. Cl. F01D 5/28; C25D 7/00

(52) U.S. Cl. CPC F01D 5/288; C25D 7/008; F05D 2230/40; F05D 2230/90; F05D 2300/175; F05D 2300/2282; F05D 2300/611

(57) ABSTRACT

A method (400) for coating a tip (106) of an aerofoil (100) is provided. The method (400) includes depositing a layer of nickel-based gamma/gamma prime chemistry (112) on the tip (106) of the aerofoil (100). The method (400) further includes depositing plurality of abrasive particles (114) on the layer of nickel-based gamma/gamma prime chemistry (112) to form a coating matrix (116). The method (400) further includes heating the tip (106) of the aerofoil (100) at a predetermined temperature in order to perform heat treatment of the coating matrix (116) and increase the strength of the coating (110) on the tip (106) of the aerofoil (100).

### FIELD OF THE DISCLOSURE

The present disclosure generally relates to an aerofoil, and in particular to a method for coating a tip of an aerofoil.

### BACKGROUND

Turbine blades in gas turbines are generally formed with tip shrouds in order to prevent leakage of air over the tips of the turbine blades. However, the necessity for cost reduction requires that blade numbers are reduced, which makes the use of shrouded blades impractical. This is due to the excessive circumferential length of the shroud. Shroudless blades can be run at higher rotational speeds due to their lower weights, but they tend to suffer from overtip leakage compromising performance. Overtip leakage can be minimised by coating the tips of shroudless blades with an abrasive material. Engine casing is also coated with an abradable lining. During operation of the gas turbine engine, the abrasive tip machines a track in the lining which results in good control of leakage around the tips of the turbine blades. Such blades are typically formed as single crystals of a metal alloy to withstand the elevated temperatures in the moving parts of the gas turbine engine.

For a shroudless turbine blade, an abrasive tip coating generally consists of a ceramic grit, such as cubic boron nitride (cBN) particles or silicon carbide (SiC) particles, embedded in a matrix of refractory coating. The refractory coating is relatively ductile and has the disadvantage that it may suffer from creep. In addition, the ceramic grit may be oxidised. A further disadvantage is that the abrasive tip coating itself may be completely lost during the operation of the gas turbine engine.

In some applications, the abrasive tip coating consists of an abrasive coating of the cBN particles held in a matrix of MCrAlY (where M is one or more of nickel, cobalt and iron, Cr is chromium, Al is aluminium, and Y is one or more of yttrium, ytterbium, lanthanum and other rare earth metals, or aluminide bond coatings) applied by composite electroplating. A ductile/brittle transition temperature of MCrAlY is relatively low. The relatively low ductile/brittle transition temperature of MCrAlY implies that high operating temperatures of the turbine blade tips coated in this way should be kept low so as to enable the MCrAlY matrix to have sufficient strength to retain the cBN particles.

Therefore, upon occurrence of the high operating temperatures of the turbine blade tips, the MCrAlY matrix may have insufficient strength to retain the cBN particles. This may render the abrasive tip coating useless in shroudless turbine blades.

In some applications, the abrasive tip coating consists of an abrasive coating of the cBN particles held in a matrix of gamma/gamma prime chemistry. However, such abrasive tip coating may have a hot strength of less than 10 MPa at temperatures above 1000° C. As a result, such abrasive tip coating may have insufficient strength to hold the abrasive particles (cBN particles) in place due to shear loads imparted into the abrasive tip coating. Therefore, there exists a need for a method for improved coating of a tip of a shroudless turbine blade.

### SUMMARY

As used herein, the term “nickel-based gamma/gamma prime chemistry” means either nickel-based gamma chemistry or nickel-based gamma prime chemistry.

According to a first aspect there is provided a method for coating a tip of an aerofoil. The method includes depositing a layer of nickel-based gamma/gamma prime chemistry on the tip of the aerofoil. The method further includes depositing plurality of abrasive particles on the layer of nickel-based gamma/gamma prime chemistry to form a coating matrix. The method further includes heating the tip of the aerofoil at a predetermined temperature in order to perform heat treatment of the coating matrix and form a high-strength coating on the tip of the aerofoil.

Heat treatment of the coating matrix at the predetermined temperature (greater than at least 1000° C.) may increase the hot strength to greater than 10 MPa at temperatures above 1000° C. In other words, heating of the tip of the aerofoil at the predetermined temperature may form required microstructures which may be compatible with a single crystal base material of the aerofoil. The high-strength coating may not suffer from creep. In addition, the high-strength coating may be relatively less oxidised as compared to already known coatings consisting of cubic boron nitride (cBN) particles embedded in a refractory coating or MCrAlY.

Due to heat treatment of the coating matrix, the ductile/brittle transition temperature of nickel-based gamma/gamma prime chemistry is relatively high. The relatively high ductile/brittle transition temperature of nickel-based gamma/gamma prime chemistry implies that the layer of nickel-based gamma/gamma prime chemistry may have sufficient strength to retain the plurality of abrasive particles. Moreover, heat treatment of the nickel-based gamma/gamma prime chemistry leads to formation of gamma/gamma prime super alloy structure with high strength. In other words, the coating matrix may have sufficient strength to hold the abrasive particles in place in the presence of shear loads imparted into the high-strength coating. As a result, when the aerofoil having the tip coated by the high-strength coating is used as a shroudless turbine blade in a gas turbine engine, overtip leakage may be minimised.

In some embodiments, heating the tip of the aerofoil further includes induction heating of the tip. The induction heating of the tip may include heating by an induction coil. Induction heating is an efficient technique for localized heating of a component (i.e., the tip of the aerofoil). The localized induction heating of the tip may refine a structure of the coating matrix such that it has desirable properties with which the high-strength coating can withstand temperatures above 1000° C.

In some embodiments, heating the tip of the aerofoil further includes laser heating of the tip. Lasers are commonly used in industries where intense, localised heat treatment of a component is required. Thus, laser heating of the tip is another efficient technique for localized heating of a component (i.e., the tip of the aerofoil). A solid-state laser may be used for heating of the tip. The solid-state laser may be neodymium:yttrium aluminium garnet (Nd:YAG) or Nd:glass.

In some embodiments, the method further includes cooling an uncoated portion of the aerofoil during the heating of the tip at the predetermined temperature. The cooling of the uncoated portion of the aerofoil maintains a temperature of the uncoated portion below 800° C. Therefore, a temperature of a parent material of the aerofoil may be kept below 800° C. during the heat treatment of the coating matrix. As a result, properties of the material of the uncoated portion may be kept unchanged during the heat treatment of the coating matrix. In some cases, the cooling of the uncoated portion of the aerofoil may be done by air cooling through internal holes on the aerofoil.

In some embodiments, the method further includes insulating, via a heat shield, the uncoated portion of the aerofoil from the tip of the aerofoil during the heating of the tip at the predetermined temperature. Such an insulation via the heat shield may keep the temperature of the uncoated portion of the aerofoil below 800° C. and further speed up the heat treatment of the coating matrix.

In some embodiments, depositing the layer of nickel-based gamma/gamma prime chemistry on the tip of the aerofoil further includes depositing a layer of nickel and/or cobalt on the tip of the aerofoil. Depositing the layer of nickel-based gamma/gamma prime chemistry on the tip of the aerofoil further includes depositing a layer of chromium, aluminium, titanium, and/or tantalum on the layer of nickel and/or cobalt. The layer of nickel-based gamma/gamma prime chemistry may act as a thermal barrier coating on the tip of the aerofoil. Further, the layer of nickel-based gamma/gamma prime chemistry in the high-strength coating may increase a spallation resistance of the tip of the aerofoil.

In some embodiments, depositing the layer of nickel-based gamma/gamma prime chemistry on the tip of the aerofoil includes depositing the layer of nickel-based gamma/gamma prime chemistry on the tip by electroplating. The deposition of the layer of nickel-based gamma/gamma prime chemistry by electroplating may improve a corrosion resistance of the tip of the aerofoil. The deposition of the layer of nickel-based gamma/gamma prime chemistry by electroplating may also improve adhesion between the parent material of the tip and the layer of nickel-based gamma/gamma prime chemistry.

In some embodiments, depositing the plurality of abrasive particles further includes depositing the plurality of abrasive particles by electroplating. The deposition of the plurality of abrasive particles by electroplating may reduce wear and tear of the tip of the aerofoil and extend a lifetime of the aerofoil.

The deposition of the plurality of abrasive particles by electroplating may also improve adhesion between the layer of nickel-based gamma/gamma prime chemistry and the plurality of abrasive particles.

In some embodiments, depositing the layer of nickel-based gamma/gamma prime chemistry on the tip of the aerofoil further includes depositing the layer of nickel-based gamma/gamma prime chemistry by direct laser deposition. Depositing the plurality of abrasive particles on the layer of nickel-based gamma/gamma prime chemistry further includes depositing the plurality of abrasive particles by direct laser deposition. Deposition of the layer of nickel-based gamma/gamma prime chemistry on the tip of the aerofoil by direct laser deposition may involve low and controllable heat input to the tip and may also cause minimal distortion of the tip. Further, deposition of the plurality of abrasive particles on the layer of nickel-based gamma/gamma prime chemistry by direct laser deposition may involve low and controllable heat input to the layer of nickel-based gamma/gamma prime chemistry.

In some embodiments, each of the plurality of abrasive particles includes cubic boron nitride (cBN). The cBN particles are well known abrasive particles specifically for advanced wear-resistant characteristics. Therefore, the presence of the cBN particles in high-strength coating may improve wear-resistant properties of the tip of the aerofoil.

In some embodiments, the method further includes providing a vacuum or an inert atmosphere around the tip during the heating of the tip at the predetermined temperature. This may prevent oxidation of the material of the tip of the aerofoil during the heat treatment of the coating matrix.

In some embodiments, the predetermined temperature is between 1200° C. and 1300° C. Heat treatment of the coating matrix at such temperatures may increase the hot strength of the coating matrix to greater than 10 MPa at operating temperatures of greater than 1000° C.

In some embodiments, at least some of the abrasive particles are partially embedded within the layer of nickel-based gamma/gamma prime chemistry and partially extend from the layer of nickel-based gamma/gamma prime chemistry. This may enable the layer of nickel-based gamma/gamma prime chemistry to firmly hold the abrasive particles.

According to a second aspect there is provided an aerofoil for a gas turbine engine. The aerofoil includes a body extending between a root and a tip. The aerofoil further includes a high-strength coating disposed on the tip. The high-strength coating includes a layer of nickel-based gamma/gamma prime super chemistry and a plurality of abrasive particles disposed on the layer of nickel-based gamma/gamma prime chemistry.

Due to heat treatment of the coating matrix, the ductile/brittle transition temperature of nickel-based gamma/gamma prime chemistry is relatively high. The relatively high ductile/brittle transition temperature of nickel-based gamma/gamma prime chemistry implies that the nickel-based gamma/gamma prime chemistry may have sufficient strength to retain the plurality of abrasive particles during the operation of the gas turbine engine. Moreover, heat treatment of the nickel-based gamma/gamma prime chemistry leads to formation of gamma/gamma prime super alloy structure with high strength. As a result, when the aerofoil of the present disclosure is used as a shroudless turbine blade in the gas turbine engine, overtip leakage may be minimised.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed). The gearbox may be a reduction gearbox (in that the output to the fan is a lower rotational rate than the input from the core shaft). Any type of gearbox may be used.

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. The bypass duct may be substantially annular. The bypass duct may be radially outside the engine core. The radially outer surface of the bypass duct may be defined by a nacelle and/or a fan case.

Specific thrust of an engine may be defined as the net thrust of the engine divided by the total mass flow through the engine. At cruise conditions, the specific thrust of an engine described and/or claimed herein may be less than (or on the order of) any of the following: 110 Nkg-1s, 105 Nkg-1s, 100 Nkg-1s, 95 Nkg-1s, 90 Nkg-1s, 85 Nkg-1s or 80 Nkg-1s. The specific thrust may be in an inclusive range bounded by any two of the values in the previous sentence (i.e. the values may form upper or lower bounds), for example in the range of from 80 Nkg-1s to 100 Nkg-1s, or 85 Nkg-1s to 95 Nkg-1s. Such engines may be particularly efficient in comparison with conventional gas turbine engines.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre.

The fan of a gas turbine as described and/or claimed herein may have any desired number of fan blades, for example 14, 16, 18, 20, 22, 24 or 26 fan blades.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a perspective view of an aerofoil of the gas turbine engine of FIG. 1, according to an embodiment of the present disclosure;

FIG. 3 illustrates an apparatus for depositing a layer of nickel-based gamma/gamma prime chemistry on a tip of the aerofoil of FIG. 2, according to an embodiment of the present disclosure;

FIG. 4A illustrates an apparatus for depositing a layer of nickel and/or cobalt on a tip of the aerofoil of FIG. 2, according to an embodiment of the present disclosure;

FIG. 4B illustrates an apparatus for depositing a layer of chromium, aluminium, titanium, and/or tantalum on the layer of nickel and/or cobalt deposited by the apparatus of FIG. 4A, and thereby form the layer of nickel-based gamma/gamma prime chemistry, according to an embodiment of the present disclosure;

FIG. 5 illustrates an apparatus for depositing a plurality of abrasive particles on the layer of nickel-based gamma/gamma prime chemistry deposited by the apparatus of FIG. 3, and thereby form a coating matrix, according to an embodiment of the present disclosure;

FIG. 6 illustrates an apparatus for depositing a layer of nickel-based gamma/gamma prime chemistry on a tip of the aerofoil of FIG. 2, and further depositing a plurality of abrasive particles on the layer of nickel-based gamma/gamma prime chemistry, and thereby form a coating matrix, according to an embodiment of the present disclosure;

FIG. 7 illustrates an apparatus for heat treatment of the coating matrix formed by the apparatus of FIG. 5 and/or the apparatus of FIG. 6, and thereby form a high-strength coating on a tip of the aerofoil of FIG. 2, according to an embodiment of the present disclosure;

FIG. 8 illustrates an apparatus for heat treatment of the coating matrix formed by the apparatus of FIG. 5 and/or the apparatus of FIG. 6, and thereby form a high-strength coating on a tip of the aerofoil of FIG. 2, according to another embodiment of the present disclosure;

FIG. 9 is an enlarged view of the tip of the aerofoil illustrating the high-strength coating on the tip, according to an embodiment of the present disclosure; and

FIG. 10 is a flowchart illustrating a method for coating a tip of the aerofoil of FIG. 2, according to an embodiment of the present disclosure.

### DETAILED DESCRIPTION

Aspects and embodiments of the present disclosure will now be discussed with reference to the accompanying figures. Further aspects and embodiments will be apparent to those skilled in the art.

As used herein, the term “nickel-based gamma/gamma prime chemistry” means either nickel-based gamma chemistry or nickel-based gamma prime chemistry.

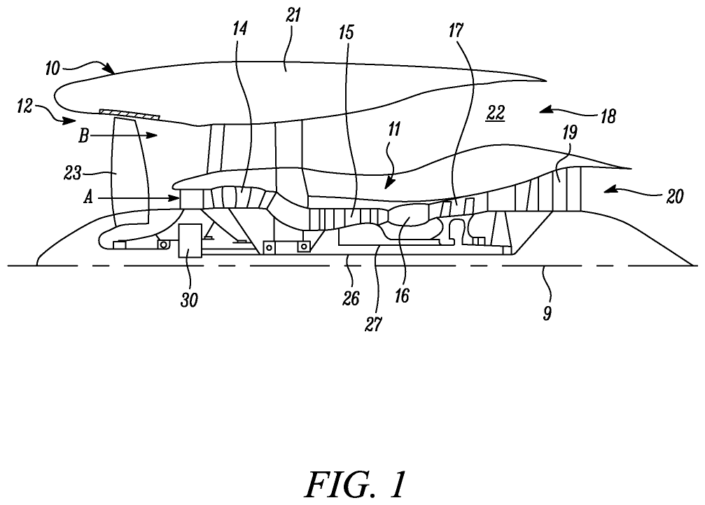

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high pressure compressor 15, combustion equipment 16, a high pressure turbine 17, a low pressure turbine 19, and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core exhaust nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

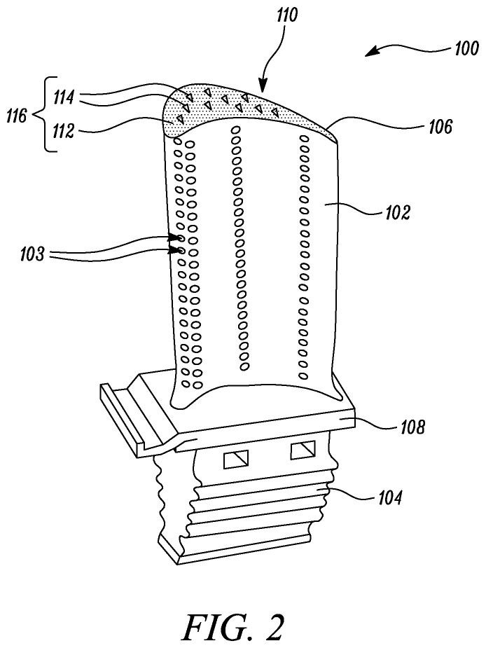

FIG. 2 is a perspective view of an aerofoil 100 of the gas turbine engine 10 of FIG. 1, according to an embodiment of the present disclosure. In some embodiments, the aerofoil 100 is a turbine blade. In some embodiments, the aerofoil 100 is a turbine blade of the high pressure turbine 17 (shown in FIG. 1). In some embodiments, the aerofoil 100 is a turbine blade of the low pressure turbine 19. In the illustrated embodiment of FIG. 2, the aerofoil 100 is a shroudless turbine blade.

The aerofoil 100 includes a body 102 extending between a root 104 and a tip 106. The aerofoil 100 is mounted on a disk (not shown) for rotation at operating speeds. The root 104 is attached to the disk. The aerofoil 100 further includes a platform 108 connecting the root 104 and the body 102.

The aerofoil 100 further includes a high-strength coating 110 disposed on the tip 106. The high-strength coating 110 includes a layer of nickel-based gamma/gamma prime chemistry 112 and a plurality of abrasive particles 114 disposed on the layer of nickel-based gamma/gamma prime chemistry 112. The plurality of abrasive particles 114 and the layer of nickel-based gamma/gamma prime chemistry 112 together form a coating matrix 116. The coating matrix 116 is further heat treated to form the high-strength coating 110 on the tip 106 of the aerofoil 100.

In some embodiments, each of the plurality of abrasive particles 114 includes cubic boron nitride (cBN). The cBN particles are well known for advanced wear-resistant characteristics. Therefore, the presence of the cBN particles in the high-strength coating 110 may improve wear-resistant properties of the tip 106 of the aerofoil 100. In some embodiments, the plurality of abrasive particles 114 may include silicon carbide.

The nickel-based gamma chemistry is a continuous matrix having a face-centered-cubic (fcc) nickel-based austenitic phase that usually contains a high percentage of solid-solution elements, such as cobalt (Co), chromium (Cr), molybdenum (Mo), and Tungsten (W). The nickel-based gamma prime chemistry refers to a primary strengthening phase in nickel-based superalloys, i.e., Ni₃(Al,Ti), where Ni stands for Nickel, Al stands for Aluminium, and Ti stands for titanium. It is a coherently precipitating phase (i.e., the crystal planes of the precipitate are in registry with the gamma matrix) with an ordered fcc crystal structure.

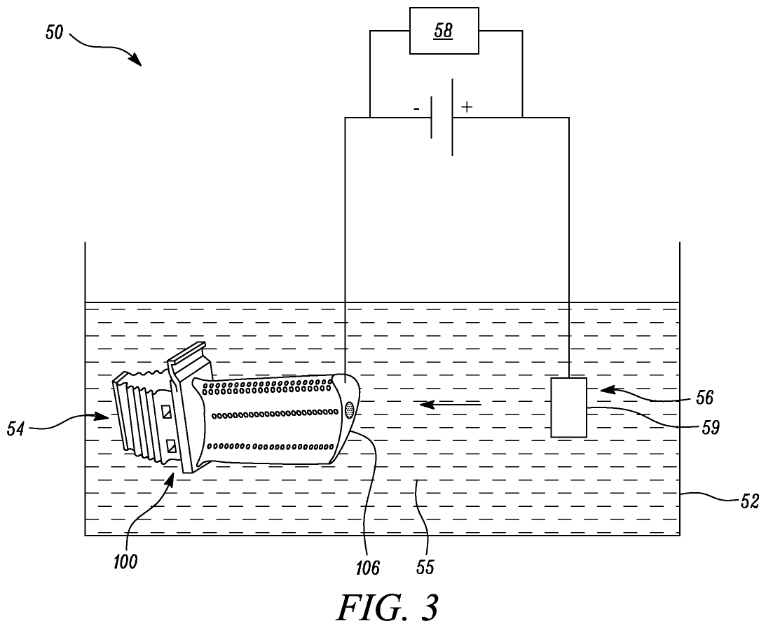

FIG. 3 illustrates an apparatus 50 for depositing the layer of nickel-based gamma/gamma prime chemistry 112 on the tip 106 of the aerofoil 100 of FIG. 2, according to an embodiment of the present disclosure. The apparatus 50 is an electroplating apparatus for depositing the layer of nickel-based gamma/gamma prime chemistry 112 on the tip 106. The apparatus 50 includes an electroplating cell 52, a cathode 54, an anode 56, and a voltage source 58. The electroplating cell 52 contains an electrolytic solution 55. The tip 106 of the aerofoil 100 which is to be coated is positioned in the electrolytic solution 55 within the electroplating cell 52 and electrically connected to the voltage source 58. The tip 106 of the aerofoil 100 serves as the cathode 54, or negatively charged electrode, of the electroplating cell 52, and is electrically connected to a negative pole of the voltage source 58. The voltage source 58 may be a source that delivers constant or varying voltage. The voltage source 58 is shown as a battery.

The apparatus 50 further includes a plating material 59 placed in the electrolytic solution 55 and electrically connected to the voltage source 58. The plating material 59 serves as the anode 56, or positively charged electrode, of the electroplating cell 52, and is electrically connected to the positive pole of the voltage source 58. The plating material 59 includes the nickel-based gamma/gamma prime chemistry which is to be deposited on the tip 106 of the aerofoil 100.

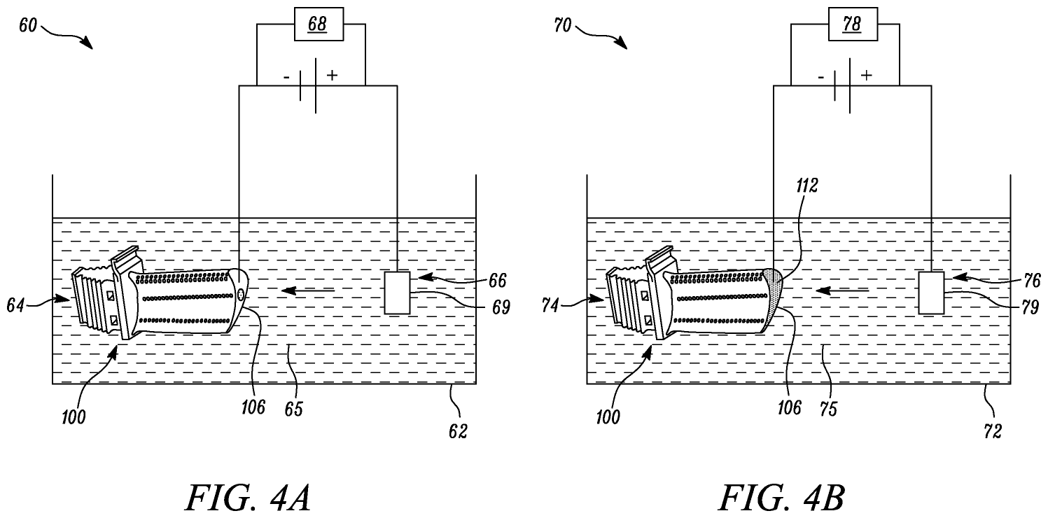

FIG. 4A illustrates an apparatus 60 for depositing a layer of nickel and/or cobalt on the tip 106 of the aerofoil 100 of FIG. 2, according to an embodiment of the present disclosure. The apparatus 60 is an electroplating apparatus for depositing the layer of nickel and/or cobalt on the tip 106. The layer to be deposited therefore includes nickel, cobalt, or any combinations thereof. The apparatus 60 includes an electroplating cell 62, a cathode 64, an anode 66, and a voltage source 68. The electroplating cell 62 contains an electrolytic solution 65. The tip 106 of the aerofoil 100 which is to be coated is positioned in the electrolytic solution 65 within the electroplating cell 62 and electrically connected to the voltage source 68. The tip 106 of the aerofoil 100 serves as the cathode 64, or negatively charged electrode, of the electroplating cell 62, and is electrically connected to a negative pole of the voltage source 68. The voltage source 68 may be a source that delivers constant or varying voltage. The voltage source 68 is shown as a battery.

The apparatus 60 further includes a plating material 69 placed in the electrolytic solution 65 and electrically connected to the voltage source 68. The plating material 69 serves as the anode 66, or positively charged electrode, of the electroplating cell 62, and is electrically connected to the positive pole of the voltage source 68. The plating material 69 includes the nickel and/or cobalt which is to be deposited on the tip 106 of the aerofoil 100. The plating material therefore includes nickel, cobalt, or any combinations thereof. In some embodiments, the plating material 69 is a suspended powder of the nickel and/or cobalt.

FIG. 4B illustrates an apparatus 70 for depositing a layer of chromium, aluminium, titanium, and/or tantalum on the layer of nickel and/or cobalt deposited by the apparatus 60 of FIG. 4A, and thereby form the layer of nickel-based gamma/gamma prime chemistry 112 (shown in FIG. 2), according to an embodiment of the present disclosure. The layer to be deposited therefore includes chromium, aluminium, titanium, tantalum, or any combinations thereof. The apparatus 70 is an electroplating apparatus for depositing the layer of chromium, aluminium, titanium, and/or tantalum on the layer of nickel and/or cobalt. The apparatus 70 includes an electroplating cell 72, a cathode 74, an anode 76, and a voltage source 78. The electroplating cell 72 contains an electrolytic solution 75. The tip 106 of the aerofoil 100 which is to be coated is positioned in the electrolytic solution 75 within the electroplating cell 72 and electrically connected to the voltage source 78. The tip 106 of the aerofoil 100 serves as the cathode 74, or negatively charged electrode, of the electroplating cell 72, and is electrically connected to a negative pole of the voltage source 78. The voltage source 78 may be a source that delivers constant or varying voltage. The voltage source 78 is shown as a battery.

The apparatus 70 further includes a plating material 79 placed in the electrolytic solution 75 and electrically connected to the voltage source 78. The plating material 79 serves as the anode 76, or positively charged electrode, of the electroplating cell 72, and is electrically connected to the positive pole of the voltage source 78. The plating material 79 includes the chromium, aluminium, titanium, and/or tantalum which is to be deposited on the layer of nickel and/or cobalt. The plating material therefore includes chromium, aluminium, titanium, tantalum, or any combinations thereof. In some embodiments, the plating material 79 is a suspended powder of the chromium, aluminium, titanium, and/or tantalum.

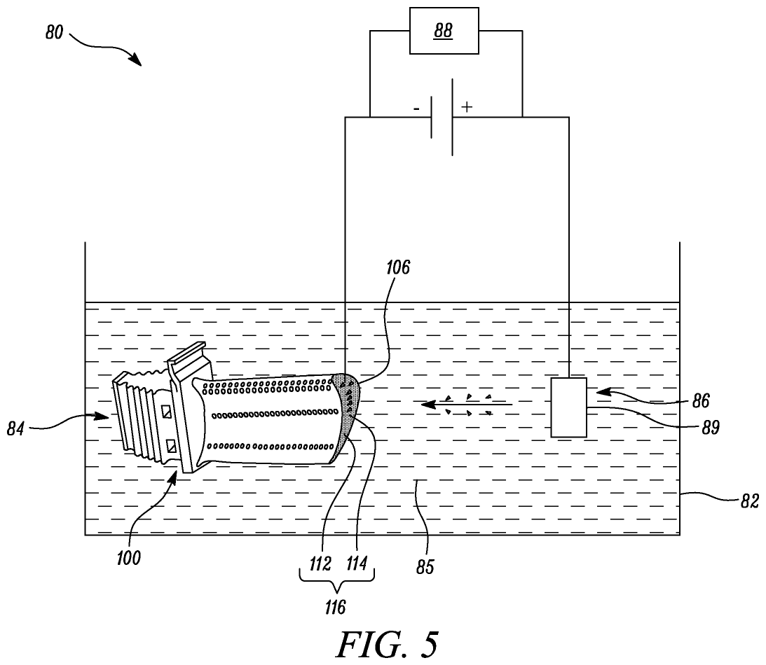

FIG. 5 illustrates an apparatus 80 for depositing the plurality of abrasive particles 114 on the layer of nickel-based gamma/gamma prime chemistry 112 deposited by the apparatus 50 of FIG. 3, and thereby form the coating matrix 116, according to an embodiment of the present disclosure. The apparatus 80 is an electroplating apparatus for depositing the plurality of abrasive particles 114 on the layer of nickel-based gamma/gamma prime chemistry 112. The apparatus 80 includes an electroplating cell 82, a cathode 84, an anode 86, and a voltage source 88. The electroplating cell 82 contains an electrolytic solution 85. The electrolytic solution 85 may include nickel sulfamate. The tip 106 of the aerofoil 100 which is to be coated is positioned in the electrolytic solution 85 within the electroplating cell 82 and electrically connected to the voltage source 88. The tip 106 of the aerofoil 100 serves as the cathode 84, or negatively charged electrode, of the electroplating cell 82, and is electrically connected to a negative pole of the voltage source 88. The voltage source 88 may be a source that delivers constant or varying voltage. The voltage source 88 is shown as a battery.

The apparatus 80 further includes a plating material 89 placed in the electrolytic solution 85 and electrically connected to the voltage source 88. The plating material 89 serves as the anode 86, or positively charged electrode, of the electroplating cell 82, and is electrically connected to the positive pole of the voltage source 88. The plating material 89 includes the plurality of abrasive particles 114 which are to be deposited on the layer of nickel-based gamma/gamma prime chemistry 112.

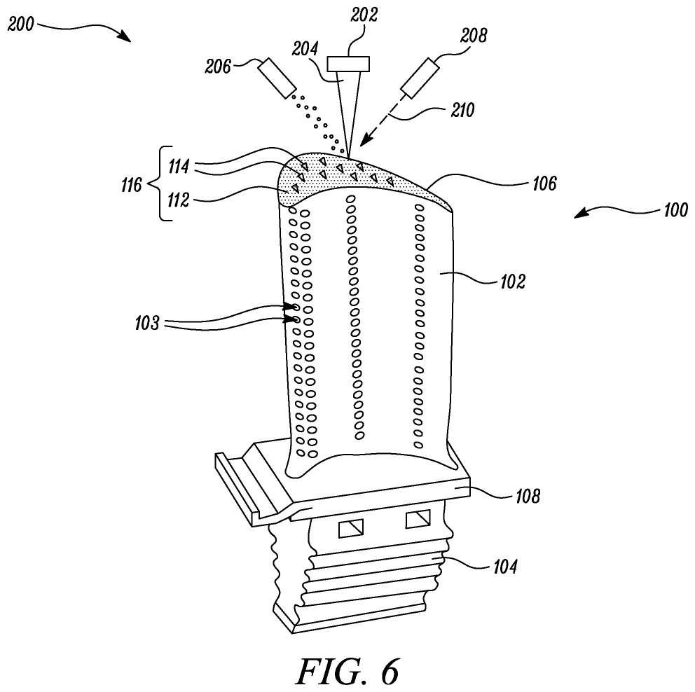

FIG. 6 illustrates an apparatus 200 for depositing the layer of nickel-based gamma/gamma prime chemistry 112 on the tip of the aerofoil 100 of FIG. 2, and further depositing the plurality of abrasive particles 114 on the layer of nickel-based gamma/gamma prime chemistry 112, and thereby form the coating matrix 116, according to an embodiment of the present disclosure. The apparatus 200 includes a laser unit 202 configured to emit a laser beam 204 towards the tip 106 of the aerofoil 100. The laser unit 202 may be a solid-state laser. The solid-state laser may be neodymium:yttrium aluminium garnet (Nd:YAG) or Nd:glass. The apparatus 200 further includes a feeder 206 configured to feed powder of nickel-based gamma/gamma prime chemistry and the plurality of abrasive particles 114. The feeder 206 may include a nozzle.

The apparatus 200 is configured to deposit the layer of nickel-based gamma/gamma prime chemistry 112 on the tip 106 by direct laser deposition through the laser beam 204. For depositing the layer of nickel-based gamma/gamma prime chemistry 112 on the tip 106 by direct laser deposition, the feeder 206 feeds the powder of nickel-based gamma/gamma prime chemistry towards the tip 106. The apparatus 200 is further configured to deposit the plurality of abrasive particles 114 on the layer of nickel-based gamma/gamma prime chemistry 112 by direct laser deposition through the laser beam 204. For depositing the plurality of abrasive particles 114 on the layer of nickel-based gamma/gamma prime chemistry 112 by direct laser deposition, the feeder 206 feeds the plurality of abrasive particles 114 towards the tip 106. The deposition of the plurality of abrasive particles 114 on the layer of nickel-based gamma/gamma prime chemistry 112 leads to formation of the coating matrix 116. In some embodiments, the feeder 206 may feed a mixture of the powder of nickel-based gamma/gamma prime chemistry and the plurality of abrasive particles 114.

The apparatus 200 further includes a shielding unit 208 configured to emit a shielding gas 210 around the laser beam 204. The shielding unit 208 may include a nozzle to emit the shielding gas 210 around the laser beam 204. In an example, the shielding gas 210 may include at least one of nitrogen, helium, and argon. The shielding gas 210 is used to protect the material of the tip 106 from oxidation during laser deposition of the layer of nickel-based gamma/gamma prime chemistry 112 and the plurality of abrasive particles 114. In other words, the shielding gas 210 provides an inert atmosphere around the tip 106.

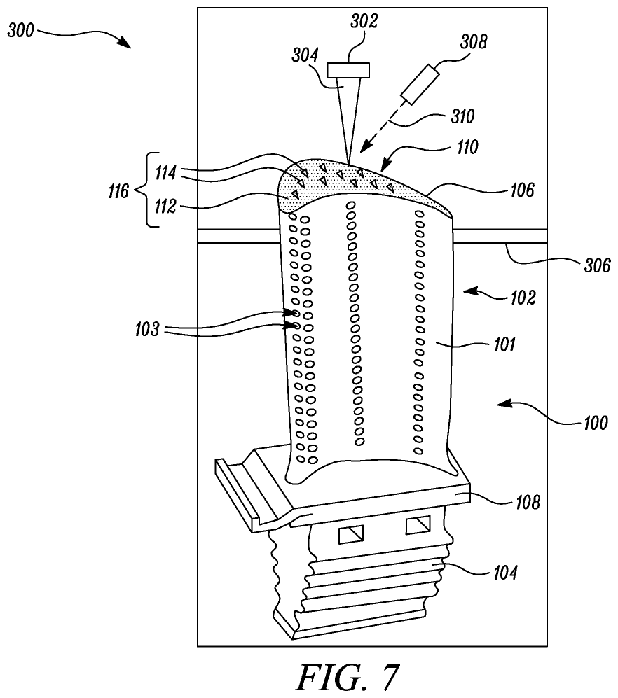

FIG. 7 illustrates an apparatus 300 for heat treatment of the coating matrix 116 formed by the apparatus 80 of FIG. 5 and/or the apparatus 200 of FIG. 6 and thereby form the high-strength coating 110 on the tip 106 of the aerofoil 100, according to an embodiment of the present disclosure. The apparatus 300 includes a laser unit 302 configured to emit a laser beam 304 towards the tip 106 of the aerofoil 100. The laser unit 302 may be a solid-state laser. The laser unit 302 may be the same as the laser unit 202 (shown in FIG. 6). The laser unit 302 is configured to heat the tip 106 of the aerofoil 100 at a predetermined temperature and perform the heat treatment of the coating matrix 116. In some embodiments, the predetermined temperature is between 1200° C. and 1300° C. Heat treatment of the coating matrix 116 at such temperatures may increase the hot strength of the coating matrix 116 to greater than 10 MPa at operating temperatures of greater than 1000° C.

The apparatus 300 further includes a shielding unit 308 configured to emit a shielding gas 310 around the laser beam 304. The shielding unit 308 may be the same as the shielding unit 208 shown in FIG. 6. The shielding gas 310 is used to protect the material of the tip 106 from oxidation during heat treatment of the coating matrix 116. In other words, the shielding gas 310 provides the inert atmosphere around the tip 106. Once the coating matrix 116 is heat treated, the coating matrix 116 becomes the high-strength coating 110. In some cases, the heat treatment of the coating matrix 116 may be conducted in a vacuum.

The aerofoil 100 includes an uncoated portion 101 that is separate from the tip 106. In some embodiments, the aerofoil 100 includes internal holes 103 for air cooling of the uncoated portion 101 of the aerofoil 100 during the heating of the tip 106 via the laser beam 304. The cooling of the uncoated portion 101 of the aerofoil 100 maintains a temperature of the uncoated portion 101 below 800° C. Therefore, a temperature of the parent material of the aerofoil 100 may be kept below 800° C. during the heat treatment of the coating matrix 116. As a result, properties of the material of the uncoated portion 101 may be kept unchanged during the heat treatment of the coating matrix 116. In some cases, a cooling jacket may also be used around the uncoated portion 101 for cooling purposes.

The apparatus 300 further includes a heat shield 306 to insulate the uncoated portion 101 of the aerofoil 100 from the tip 106 of the aerofoil 100 during the heating of the tip 106 at the predetermined temperature. Such an insulation may keep the temperature of the uncoated portion 101 of the aerofoil 100 below 800° C. and further speed up the heat treatment of the coating matrix 116.

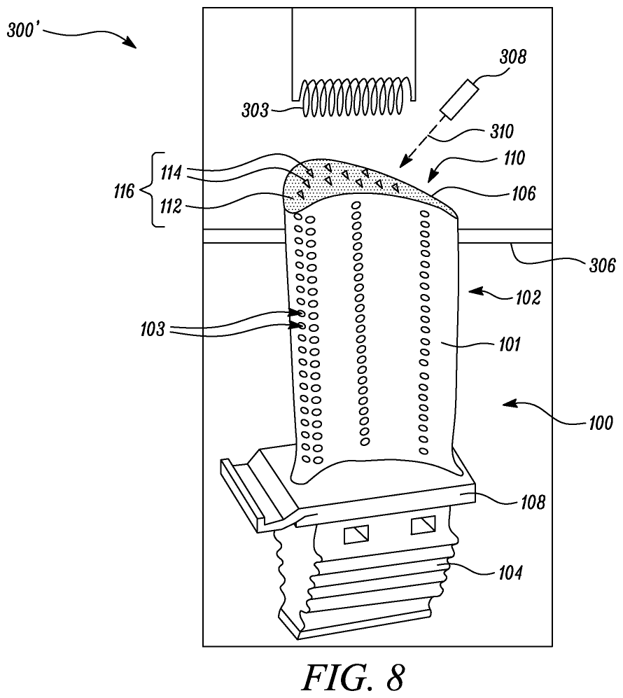

FIG. 8 illustrates an apparatus 300′ for heat treatment of the coating matrix 116 formed by the apparatus 80 of FIG. 5 and/or the apparatus 200 of FIG. 6 and thereby form the high-strength coating 110 on the tip 106 of the aerofoil 100, according to an embodiment of the present disclosure. The apparatus 300′ is substantially similar to the apparatus 300 of FIG. 7, with common components being referred to by the same numerals. However, the apparatus 300′ does not include a laser unit (i.e., the laser unit 302 shown in FIG. 7). Instead, the apparatus 300′ includes an induction heater 303 to heat the tip 106 and perform the heat treatment of the coating matrix 116. The induction heater 303 may be an induction coil.

Referring to FIGS. 7 and 8, heat treatment of the coating matrix at the predetermined temperature (greater than at least 1000° C.) may increase the hot strength of the coating matrix 116 to greater than 10 MPa at temperatures above 1000° C. In other words, heating of the tip 106 of the aerofoil 100 at the predetermined temperature may form required microstructures which may be compatible with a single crystal base material of the aerofoil 100. The high-strength coating 110 may not suffer from creep. In addition, the high-strength coating 110 may be relatively less oxidised as compared to already known coatings consisting of cubic boron nitride (cBN) particles embedded in a refractory coating or MCrAlY.

Due to heat treatment of the coating matrix 116, the ductile/brittle transition temperature of nickel-based gamma/gamma prime chemistry is relatively high. The relatively high ductile/brittle transition temperature of nickel-based gamma/gamma prime chemistry implies that the layer of nickel-based gamma/gamma prime chemistry 112 may have sufficient strength to retain the plurality of abrasive particles 114. Moreover, heat treatment of the nickel-based gamma/gamma prime chemistry leads to formation of gamma/gamma prime super alloy structure with high strength. In other words, the coating matrix 116 may have sufficient strength to hold the abrasive particles 114 in place in the presence of shear loads imparted into the high-strength coating 110. As a result, when the aerofoil 100 having the tip 106 coated by the high-strength coating 110 is used as a shroudless turbine blade in the gas turbine engine 10 (shown in FIG. 1), overtip leakage may be minimised.

Moreover, induction heating is an efficient technique for localized heating of a component (i.e., the tip 106 of the aerofoil 100). The localized induction heating of the tip 106 may refine a structure of the coating matrix 116 such that it has desirable properties with which the high-strength coating 110 can withstand temperatures above 1000° C.

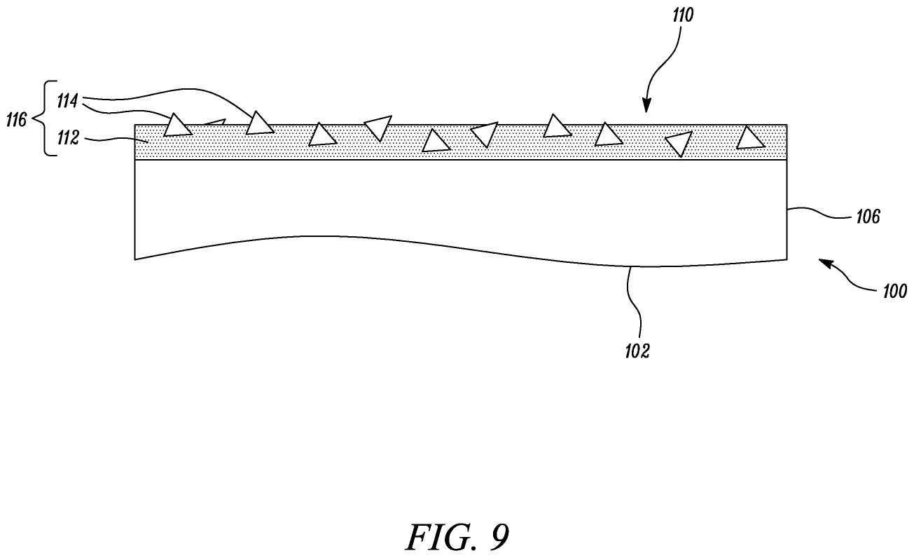

FIG. 9 is an enlarged view of the tip 106 of the aerofoil 100 illustrating the high-strength coating 110 on the tip 106, according to an embodiment of the present disclosure. As shown in FIG. 9, at least some of the abrasive particles 114 are partially embedded within the layer of nickel-based gamma/gamma prime chemistry 112 and partially extend from the layer of nickel-based gamma/gamma prime chemistry 112.

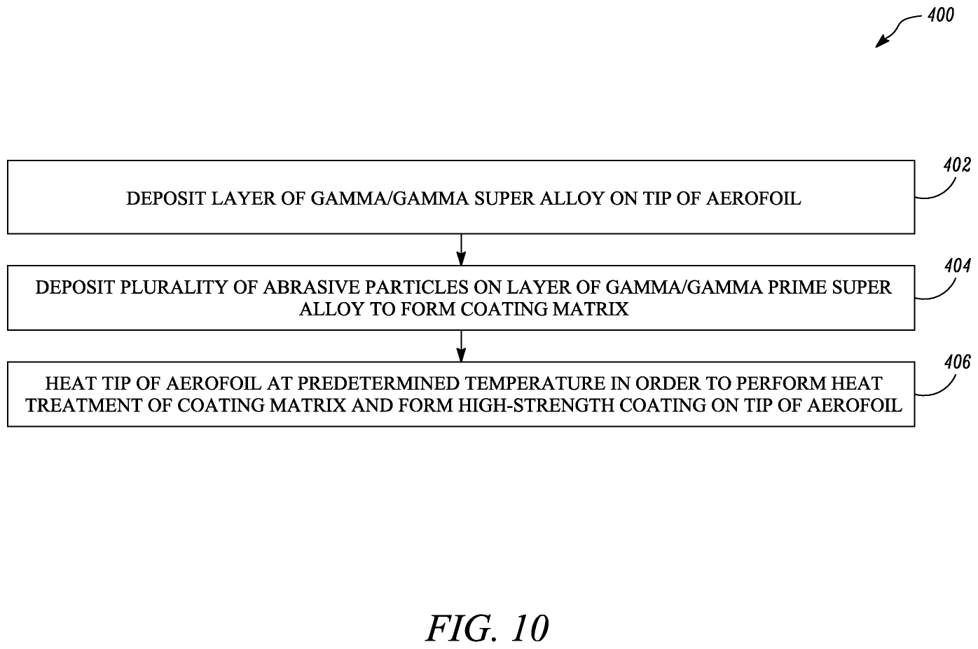

FIG. 10 is a flowchart illustrating a method 400 for coating the tip 106 of the aerofoil 100 of FIG. 2, according to an embodiment of the present disclosure. Referring to FIGS. 2 to 10, at step 402, the method 400 includes depositing the layer of nickel-based gamma/gamma prime chemistry 112 on the tip 106 of the aerofoil 100. Referring to FIGS. 3 and 10, depositing the layer of nickel-based gamma/gamma prime chemistry 112 on the tip 106 of the aerofoil 100 further includes depositing the layer of nickel-based gamma/gamma prime chemistry 112 on the tip 106 by electroplating. Referring to FIGS. 4A and 10, depositing the layer of nickel-based gamma/gamma prime chemistry 112 on the tip 106 of the aerofoil 100 further includes depositing the layer of nickel and/or cobalt on the tip 106 of the aerofoil 100. Referring to FIGS. 4B and 10, depositing the layer of nickel-based gamma/gamma prime chemistry 112 on the tip 106 of the aerofoil 100 further includes depositing the layer of chromium, aluminium, titanium, and/or tantalum on the layer of nickel and/or cobalt. Referring to FIGS. 6 and 10, depositing the layer of nickel-based gamma/gamma prime chemistry 112 on the tip 106 of the aerofoil 100 further includes depositing the layer of nickel-based gamma/gamma prime chemistry 112 on the tip 106 by direct laser deposition.

Referring to FIGS. 2 to 10, at step 404, the method 400 further includes depositing the plurality of abrasive particles 114 on the layer of nickel-based gamma/gamma prime chemistry 112 to form the coating matrix 116. Referring to FIGS. 5 and 10, depositing the plurality of abrasive particles 114 further includes depositing the plurality of abrasive particles 114 by electroplating. Referring to FIGS. 6 and 10, depositing the plurality of abrasive particles 114 on the layer of nickel-based gamma/gamma prime chemistry 112 further includes depositing the plurality of abrasive particles 114 by direct laser deposition.

Referring to FIGS. 2, 7, 8, and 10, at step 406, the method 400 further includes heating the tip 106 of the aerofoil 100 at the predetermined temperature in order to perform heat treatment of the coating matrix 116 and form the high-strength coating 110 on the tip 106 of the aerofoil 100. Referring to FIGS. 7 and 10, heating the tip 106 of the aerofoil 100 further includes laser heating of the tip 106. Referring to FIGS. 8 and 10, heating the tip 106 of the aerofoil 100 further includes induction heating of the tip 106. Referring again to FIGS. 2, 7, 8, and 10, the method 400 further includes providing the vacuum or the inert atmosphere around the tip 106 during the heating of the tip 106 at the predetermined temperature. The method 400 further includes cooling the uncoated portion 101 of the aerofoil 100 during the heating of the tip 106 at the predetermined temperature. The cooling of the uncoated portion 101 of the aerofoil 100 maintains the temperature of the uncoated portion 101 below 800° C. The method 400 further includes insulating, via the heat shield 306, the uncoated portion 101 of the aerofoil 100 from the tip 106 of the aerofoil 100 during the heating of the tip 106 at the predetermined temperature.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method for coating a tip of an aerofoil for a gas turbine engine, the method comprising:
depositing a layer of nickel-based gamma/gamma prime chemistry on the tip of the aerofoil;
depositing plurality of abrasive particles on the layer of nickel-based gamma/gamma prime chemistry to form a coating matrix; and
heating the tip of the aerofoil at a predetermined temperature in order to perform heat treatment of the coating matrix and increase the strength of the coating on the tip of the aerofoil.

2. The method of claim 1, wherein heating the tip of the aerofoil further comprises induction heating of the tip.

3. The method of claim 1, wherein heating the tip of the aerofoil further comprises laser heating of the tip.

4. The method of claim 1, further comprising cooling an uncoated portion of the aerofoil during the heating of the tip at the predetermined temperature, wherein the cooling of the uncoated portion of the aerofoil maintains a temperature of the uncoated portion below 800° C.

5. The method of claim 4, further comprising insulating, via a heat shield, the uncoated portion of the aerofoil from the tip of the aerofoil during the heating of the tip at the predetermined temperature.

6. The method of claim 1, wherein depositing the layer of nickel-based gamma/gamma prime chemistry on the tip of the aerofoil further comprises:
depositing a layer of nickel and/or cobalt on the tip of the aerofoil; and
depositing a layer of chromium, aluminium, titanium, and/or tantalum on the layer of nickel and/or cobalt.

7. The method of claim 1, wherein depositing the layer of nickel-based gamma/gamma prime chemistry on the tip of the aerofoil comprises depositing the layer of nickel-based gamma/gamma prime chemistry on the tip by electroplating.

8. The method of claim 1, wherein depositing the plurality of abrasive particles further comprises depositing the plurality of abrasive particles by electroplating.

9. The method of claim 1, wherein:
depositing the layer of nickel-based gamma/gamma prime chemistry on the tip of the aerofoil further comprises depositing the layer of nickel-based gamma/gamma prime chemistry by direct laser deposition; and
depositing the plurality of abrasive particles on the layer of nickel-based gamma/gamma prime chemistry further comprises depositing the plurality of abrasive particles by direct laser deposition.

10. The method of claim 1, wherein each of the plurality of abrasive particles comprises cubic boron nitride.

11. The method of claim 1, further comprising providing a vacuum or an inert atmosphere around the tip during the heating of the tip at the predetermined temperature.

12. The method of claim 1, wherein the predetermined temperature is between 1200° C. and 1300° C.

13. The method of claim 1, wherein at least some of the abrasive particles are partially embedded within the layer of nickel-based gamma/gamma prime chemistry and partially extend from the layer of nickel-based gamma/gamma prime chemistry.

14. An aerofoil for a gas turbine engine, the aerofoil comprising:
a body extending between a root and a tip; and
a coating disposed on the tip, the coating comprising a layer of nickel-based gamma/gamma prime chemistry and a plurality of abrasive particles disposed on the layer of nickel-based gamma/gamma prime chemistry, the strength of the coating being increased by heating the tip of the aerofoil at a predetermined temperature in order to perform heat treatment of the coating matrix.

15. The aerofoil of claim 14, wherein the aerofoil is a turbine blade.
